(19) United States
(12) Patent Application Publication
(10) Pub. No.: US 2009/0174196 A1
(43) Pub. Date: Jul. 9, 2009

(54) LOCKING DEVICE FOR SLIDING DOORS AND WINDOWS

(76) Inventor: Tyrone Stacey Chambers, Grants Pass, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 12/347,102

(22) Filed: Dec. 31, 2008

Related U.S. Application Data
(60) Provisional application No. 61/018,843, filed on Jan. 3, 2008.

(51) Int. Cl. E05C 17/04

(52) U.S. Cl. 292/338

(57) ABSTRACT

Embodiments herein provide a locking device for sliding doors and windows. In an embodiment, a locking device may be placed in an appropriate position between a frame and an associated sliding door or window to prevent sliding of the door or window when the locking device is in the locked position. The locking device may be configured to remain coupled to the frame and the associated door or window when the locking device is in an unlocked position.

### CROSS REFERENCE TO RELATED APPLICATIONS

The present application claims priority to U.S. Provisional Patent Application No. 61/018,843, filed Jan. 3, 2008, entitled “LOCKKING IS A WORKING SECURITY LOCK FOR SLIDING GLASS DOORS AND SLIDING WINDOWS,” the entire disclosure of which is hereby incorporated by reference in its entirety.

### TECHNICAL FIELD

Embodiments herein relate to a locking device for sliding doors and windows.

### BACKGROUND

Manufactured locks and/or latches provided with many sliding doors or windows may ineffectively secure the door or window in a closed and locked position. Such locks and latches may be vulnerable to breach, for example by a home invader.

To address the potential lack of security provided by many locks and latches, individuals may utilize secondary devices to enhance the security of the door or window. Such secondary devices may include additional latching mechanisms, bars, etc.

In some situations, individuals place a bar (stick, board, dowel, pipe, etc.) along the sliding track of a door or window to prevent the door or window from being opened. The bar then has to be removed and stored each time the door or window is opened, and replaced along the track the next time it is to be used.

Other devices utilize a spring-loaded bar that may be set in place for use. Such a device must also be removed from the door or window when not in use.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 illustrates an exemplary locking device in accordance with an embodiment;

FIG. 2 illustrates a cross-sectional view of the locking device of FIG. 1;

FIG. 3 illustrates an exploded view of the locking device of FIGS. 1 and 2;

FIGS. 4, 5, 6, and 7 provide a series of illustrations of a locking device in various stages of engagement;

FIGS. 8, 9, 10, and 11 provide a series of illustrations of a locking device in various stages of engagement;

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

Embodiments herein provide a locking device for sliding doors and windows. In an embodiment, a locking device may be placed in an appropriate position between a frame and an associated sliding door or window to prevent sliding of the door or window when the locking device is in the locked position. In an embodiment, the locking device may be configured to remain coupled to the frame and the associated door or window when the locking device is in an unlocked position.

In an embodiment, there is provided a locking device, comprising a first member having a support end and a coupling end; a second member having a support end and a sliding end for slidably engaging with the coupling end of the first member; and a tensioning element coupled to the first member and configured to provide axial tension outwardly to the first and second members.

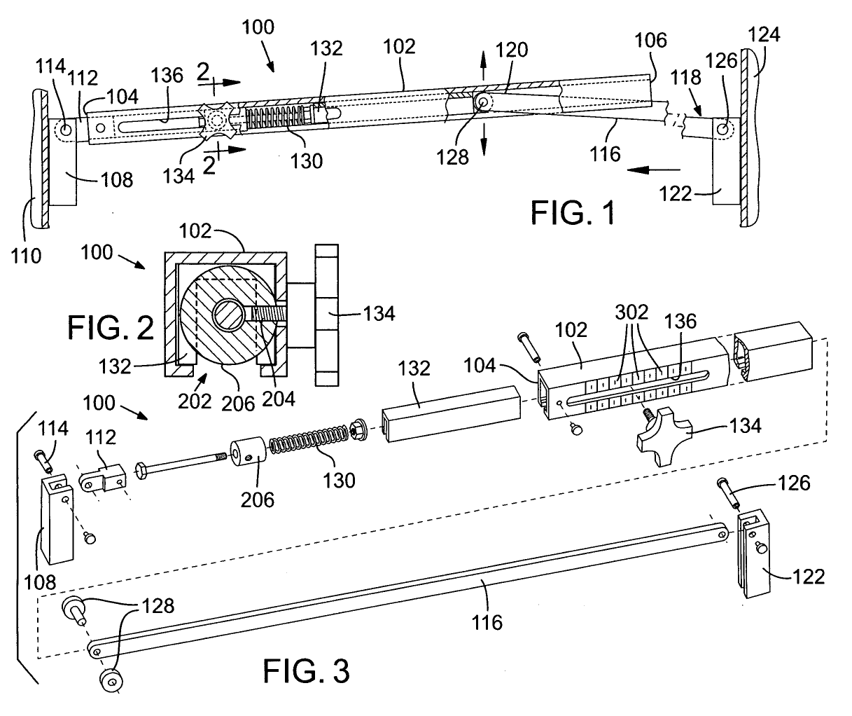

For the purpose of describing embodiments herein, the phrase “axial tension” refers to a force provided along, or in a general direction of, the longitudinal axis of the defined element, such as the longitudinal axis of the first and/or second members shown in FIG. 1.

FIG. 1 illustrates an exemplary locking device 100 in accordance with an embodiment. Device 100 has a first member 102 having a first end 104 and a second end 106. At first end 104, a support bracket 108 is provided as the intended contact point between device 100 and frame 110. Support bracket 108 is coupled to first end 104 by hinge 112 and is rotatable about pin 114 to permit alignment of support bracket 108 with frame 110. Device 100 also has a second member 116 having a first end 118 and a second end 120. At first end 118, a support bracket 122 is provided as the intended contact point between device 100 and window/door 124. Support bracket 122 is coupled to first end 118 by pin 126 and is rotatable about pin 126 to permit alignment of support bracket 122 with window/door 124.

In an embodiment, the orientation of supports 108 and 122 (coupled to a frame or to a door/window) may be reversed.

In an embodiment, second member 116 is configured to slidably engage with first member 102. At second end 120, a roller 128 may be provided to facilitate the slidable engagement of second member 116 within first member 102. Roller 128 should be construed to refer broadly to any device, such as a wheel, bearing, ball, etc. which permits relatively smooth slidable engagement between members 102 and 116. In addition, a corresponding track may be provided in first member 102 along which roller 128 may move. First member 102 has an opening in a surface (see FIG. 2) to allow second member 116 to pivot around roller 128 and to permit rotation, sliding, and/or folding movement of device 100 between a locked position and a collapsed position.

Device 100 may be secured between frame 110 and door/window 124 using a tensioning element. In an embodiment, a spring 130 may be provided to introduce axial tension laterally on supports 108 and 122 to secure device 100 between frame 110 and door/window 124. In embodiments, a tensioning element may be coupled to first member 102 and configured to provide axial tension to the first and second members 102,116 outwardly in a general direction of, or along, a longitudinal axis of first and second members 102,116.

While a spring is described above as a suitable tensioning element, other tensioning elements may be used in embodiments, such as a pneumatic or hydraulic device, a mechanical crank, gear, or lever, etc.

Spring 130 is configured to contact a stop 132, which may be integral with spring 130 or may be a separate floating stop. Stop 132 provides a coupling between spring 130 and second end 120 of second member 116. Stop 132 is illustrated as a slotted bar, but may have a variety of shapes and sizes, as desired, including solid, hollow, squared, rounded, etc. In embodiments, stop 132 may be replaced by another suitable stop, such as a dampener, a pneumatic or hydraulic stop, a movable or insertable stop, etc.

Spring 130 may be coupled to an adjustment knob 134 that is slidable along a slot 136 and which may be tightened in a desired location along slot 136. The location along slot 136 at which adjustment knob 134 is secured determines, in part, the extent of compression provided to spring 130 for a given length of device 100 in the locked position. Such a configuration enables locking device 100 to be adjusted in functioning length for use in a variety of different widths of door/window spans.

For the purposes of describing embodiments herein, the term “span” refers to the functional space to be locked by a locking device, such as the space between a sliding window and the window frame or a sliding door and the door frame.

Device 100 may be further secured between frame 110 and door/window 124 using any suitable fastening device, including screws, nails, adhesive, clamps, clips, tape, etc., in particular located at, or used in conjunction with, supports 108 and/or 122. In one embodiment, double-sided adhesive tape may be used to secure supports 108 and/or 122 to a surface.

For the purpose of describing embodiments herein, the term “frame” refers broadly to a framing element of a window or door. For the purpose of describing embodiments herein, the term “door” or “window” refers to the movable part of a door or window, not only for example the glass of a window, but rather including the border/edge of the door or window, if applicable.

For the purpose of describing embodiments herein, the term “support” refers to any suitable contact element/surface between a locking device and a frame/door/window, regardless of shape, size, etc. In an embodiment, a support, in conjunction with other components of a locking device, provide at least a partial tension or friction fit in a span of a door or window.

FIG. 2 illustrates a cross-sectional view of device 100 of FIG. 1. FIG. 2 shows first member 102 and opening 202 at the lower surface of first member 102. Knob 134 is shown with threaded shaft 204 to facilitate tightening of knob 134 in a particular location along slot 136 (shown in FIG. 1). An additional stop 206 is provided at one end of spring 130 to permit compression of spring 130 between stop 206 and stop 132.

FIG. 3 illustrates an exploded view of device 100 of FIGS. 1 and 2. FIG. 3 also illustrates an additional feature of measurement markings 302 which may be provided on first member 102 to indicate the width of the door or window span accommodated by device 100 when knob 134 is secured at the indicated measurement. Markings 302 may correspond to the width of the door or window span, and may, in an embodiment, incorporate a desired amount of tension on spring 130 to insert device 100 within the indicated width and to secure device 100 in an engaged/locked position.

While members 102 and 116 are shown with square or rectangular cross-sections, other cross-sectional shapes may be utilized, including round, oval, triangular, irregular, etc.

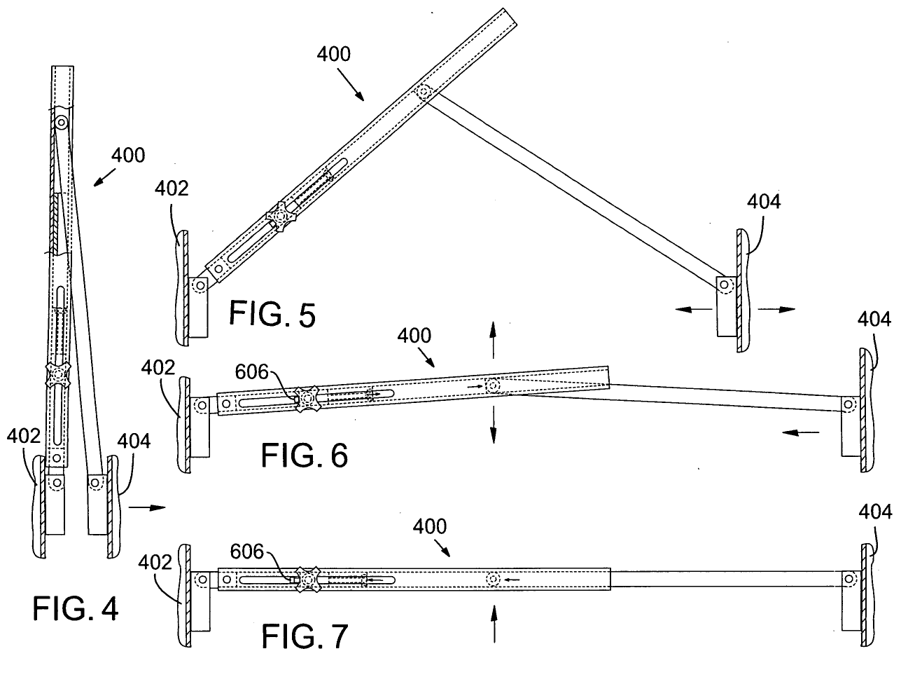

FIGS. 4, 5, 6, and 7 provide a series of illustrations of a locking device 400 in various stages of engagement, from collapsed to locked. FIG. 4 illustrates locking device 400 in a collapsed position, such as when a door or window to which device 400 is attached has been opened. As may be seen, the embodiment shown in FIG. 4 permits a substantial folding or collapse of device 400 between frame 402 and door/window 404 enabling the associated door/window 404 to be substantially opened, and further permits efficient storage or shipping of device 400, as needed. FIGS. 5 and 6 illustrate various positions of device 400 between fully collapsed (FIG. 4) and locked (FIG. 7). In addition, as shown in FIGS. 6 and 7, as device 400 is moved from a collapsed position into a locked position, the tensioning element begins to engage, and the tensioning element is moved/compressed. This relationship may be further shown in the figure by the extension of bolt 606 as device 400 moves into a locked position evidencing the movement/compression of the tensioning element and the associated movement of bolt 606.

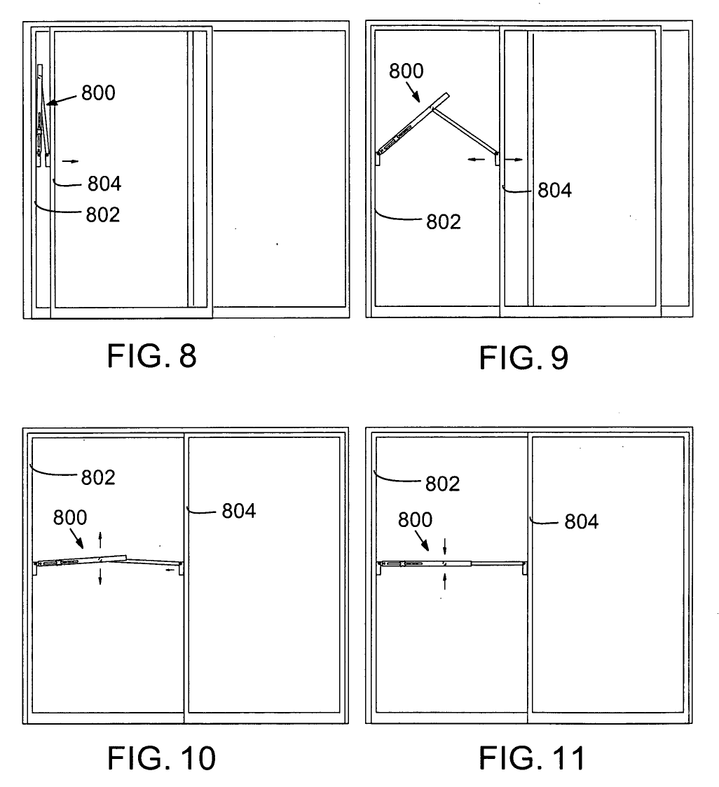

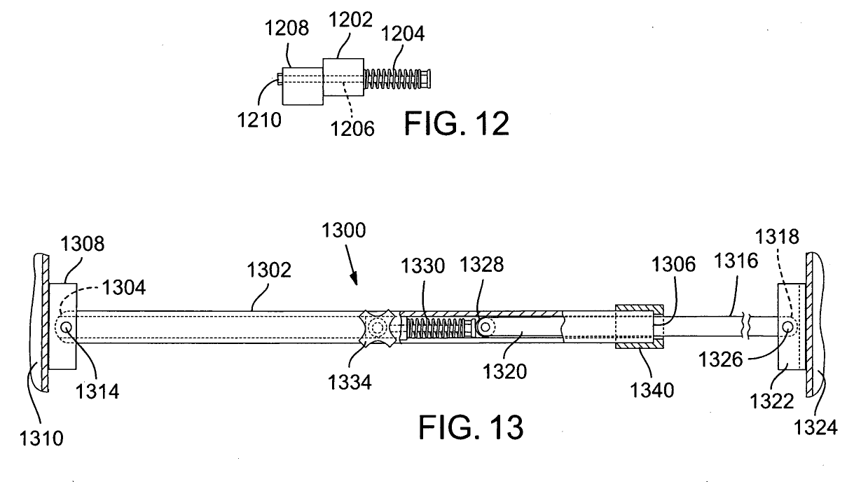

FIGS. 8, 9,10, and 11 provide a series of illustrations of a locking device 800 in various stages of engagement, from collapsed to locked, between a door frame 802 and a door 804. FIG. 8 illustrates locking device 800 in a collapsed position permitting a substantial folding or collapse of device 800 between frame 802 and door 804 enabling door 804 to be substantially opened. FIGS. 9 and 10 illustrate various positions of device 800 between fully collapsed (FIG. 8) and locked (FIG. 11).

FIGS. 8, 9, 10, and 11 are illustrated with the sliding door on the interior track of the door frame. In an embodiment in which the sliding door (or window) is on the exterior track of the frame, the portion of the locking device mounted on the door/window may be secured to the interior facing surface of the door/window and the mount/support at the opposite end of the locking device may be secured to a central framing element of the door/window. In such an embodiment, the locking device support mounted on the door/window may be turned or configured sideways to facilitate the mounting.

Although FIGS. 8, 9, 10, and 11 are illustrated with locking device 800 installed approximately at the midpoint of the height of the door and door frame, in embodiments, a locking device may be installed at any suitable height. For example, a lower height installation may be beneficial if operation with a foot or cane is desired or for easier access by a short individual or someone confined to a wheelchair. Alternatively, a higher installation may be desired to avoid access by a child.

When in a locked position, such as in FIGS. 7 and 11, a locking device may be unlocked by simply applying an upward force at or near the middle of the locking device. When the locking device disengages, the locking arms/members are permitted to slide with respect to each other. In an embodiment, the roller of the one member is permitted to slide along the track or interior of the other member. To engage the locking device, the motion may be reversed. Typically, to engage the locking device, a user would close the associated door causing the locking device to move from a collapsed position to an extended position (such as shown in FIG. 4 through FIG. 7). To ensure the locking device is engaged, a small downward force may be applied at or near the center of the locking device, such as by pressing down on the locking device with a hand or foot.

To install a locking device in accordance with an embodiment herein, a desired height may be selected and measured on opposite facing surfaces of the frame/door/window. The locking device may be inserted into the desired location in a variety of ways. The locking device may be compressed by hand and then placed within the door/window span before allowing the device to expand under tension to the desired width. In such an embodiment, the width of the device may be set based on the width of the span, for example, by aligning a feature of the device (such as part of the tensioning element) with markings on the device.

In an alternative embodiment, for example using a device as shown in FIG. 1, the device may be placed in the door/window span. The knob may be loosened and slid along the track of the first member toward the second member to reside in an engaged position. The tensioning element (such as a spring) may be engaged/compressed, and, during engagement/compression the knob may be tightened to secure the device in place.

In an alternative embodiment, the tensioning element may be pre-tensioned using an additional element, such as a spacer, before tightening the knob. FIG. 12 illustrates a tensioning element including a stop 1202 and spring 1204 configured on bolt 1206. Stop 1202 is caused to compress spring 1204 along bolt 1206 by pressure, such as exerted on an associated knob, on the ends of the device, or other element (not shown). While compressed, a spacer 1208 may be placed between the head 1210 of bolt 1206 and stop 1202 maintaining spring 1204 in a compressed state.

During installation, the tensioning element utilizing spacer 1208 may be brought into contact with the next component in the interior of the locking device (stop, roller, second member, etc.) while the device is extended to the desired width. Once aligned and extended, spacer 1208 may be removed causing spring 1204 to expand and secure the associated device in place by axial tension.

Spacer 1208 is shown as a simple rectangular element; however, other shapes, sizes, and/or configurations may be utilized. For example, spacer 1208 may be configured to clip to bolt 1206 to provide a more secure connection. In another embodiment, spacer 1208 may be coupled in some manner to the locking device itself so that it is not misplaced.

FIG. 13 illustrates an alternate embodiment of a locking device 1300. Device 1300 has a first member 1302 having a first end 1304 and a second end 1306. At first end 1304, a support bracket 1308 is provided as the intended contact point between device 1300 and a frame/door/window 1310. Device 1300 is rotatable about coupling 1314 to permit alignment of support bracket 1308 with a frame/door/window 1310. Device 1300 also has a second member 1316 having a first end 1318 and a second end 1320. At first end 1318, a support bracket 1322 is provided as the intended contact point between device 1300 and a frame/door/window 1324. Support bracket 1322 is rotatable about coupling 1326 to permit alignment of support bracket 1322 with a frame/door/window 1324.

In an embodiment, second member 1316 is configured to slidably engage with first member 1302. At second end 1320, a roller 1328 may be provided to facilitate the slidable engagement of second member 1316 within first member 1302. Roller 1328 should be construed to refer broadly to refer to any device, such as a wheel, bearing, ball, etc. which permits relatively smooth slidable engagement between members 1302 and 1316. In addition, a corresponding track may be provided in first member 1302 along which roller 1328 may move. First member 1302 has a long opening in at least one surface to allow second member 1316 to pivot around roller 1328 and to permit rotation and/or sliding movement of device 1300 between a locked position and a collapsed position.

Device 1300 may be secured between a frame/door/window 1310,1324 using a tensioning element. In an embodiment, a spring 1330 may be provided to introduce axial tension laterally on supports 1308 and 1322 to secure device 1300 between a frame/door/window 1310,1324. In embodiments, a tensioning element may be coupled to first member 1302 and configured to provide axial tension to the first and second members 1302,1316 outwardly in a direction of a longitudinal axis of first and second members 1302,1316.

Spring 1330 may be coupled to an adjustment knob 1334, the actuation of which may increase or decrease the compression of spring 1330.

In an embodiment, a collar 1340 may be provided. Collar 1340 is configured to cover, and potentially nest, at the point where second member 1316 exits first member 1302. Collar 1340 is slidable along member 1316 (or may be configured to be slidable along member 1302 in addition or alternatively). Collar 1340 provides an additional securing element to ensure locking device 1300 does not disengage at an undesired time.

In an embodiment, if knob 1334 is designed to slide along a slot in member 1302 (similar to as shown in FIG. 1), a separate integral lock or locking pin may be provided to secure the location of knob 1334 once tightened. For example, a locking pin may be configured to be passed through member 1302, at various locations along member 1302, after knob 1334 is secured.

In embodiments, one or more parts of the locking device may be constructed from any suitable material(s), including, but not limited to brass, plastic, aluminum, steel, stainless, steel, wood, glass, ceramic, etc. In an embodiment, parts may or may not have a coating or surface treatment. Suitable coatings include anodizing, hard anodizing, electroless nickel, brite nickel, powder coating, baked enamel, sprayed enamel, dipped finish, etc.

While embodiments herein have been shown and described primarily with respect to door and windows, such a locking device may be used to secure any suitable structure having a similar opening/closing function. In addition, while the locking devices are generally shown installed in one configuration (moving in the same plane as a door and locked in a horizontal position), other installed configurations may be utilized depending on the particular structure to be secured, such as vertically locked or out of plane configurations.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A locking device, comprising:
a first member having a support end and a coupling end;
a second member having a support end and a sliding end for slidably engaging with the coupling end of the first member; and
a tensioning element coupled to the first member and configured to provide axial tension outwardly to the first and second members.

2. The locking device of claim 1, wherein at least one of the support end of the first member and the support end of the second member comprises a pivotable support bracket.

3. The locking device of claim 1, wherein the sliding end of the second member comprises a roller, wheel, bearing, or ball.

4. The locking device of claim 1, wherein the first member comprises a track to permit slidable engagement of the sliding end of the second member and to permit the second member to pivot around its sliding end.

5. The locking device of claim 1, wherein the tensioning element comprises a spring.

6. The locking device of claim 1, further comprises a knob coupled to the tensioning element to lock the tensioning element in a desired position.

7. The locking device of claim 6, wherein the first member comprises a slot and the knob is configured to slide along the slot.

8. The locking device of claim 1, wherein the first member further comprises measurement markings provided along the slot indicating a locked length of the locking device when the knob is aligned with a particular measurement marking.

9. The locking device of claim 1, further comprising a stop located in the first member and positioned between the sliding end of the second member and the tensioning element.

10. The locking device of claim 1, wherein the tensioning element comprises a spacer configured to, when engaged, maintain the tensioning element in a compressed position.

11. The locking device of claim 1, further comprising a collar configured to secure the first member and the second member in a locked position.

12. The locking device of claim 11, wherein the collar is slidably engaged with an exterior surface of the first member and/or the second member.

13. A method of installing a locking device, comprising:
providing a locking device having
a first member having a support end and a coupling end,
a second member having a support end and a sliding end for slidably engaging with the coupling end of the first member, and
a tensioning element coupled to the first member and configured to
provide axial tension outwardly to the first and second members;
compressing the tensioning element;
placing the locking device in a span to be secured; and
releasing the compressed tensioning element such that a degree of axial tension remains to secure the locking device within the span.

14. The method of claim 13, wherein compressing the tensioning element comprises manually compressing the tensioning element.

15. The method of claim 13, wherein compressing the tensioning element comprises compressing the tensioning element and inserting a spacer in the tensioning element to maintain the tensioning element in a compressed position.

16. The method of claim 15, wherein releasing the compressed tensioning element comprises removing the spacer from the tensioning element.

17. The method of claim 13, further comprising, after compressing the tensioning element, locking the tensioning element in position by actuating an associated device.

18. The method of claim 17, wherein the associated device comprises a knob, and actuating the knob comprises sliding the knob into an engaged position and then tightening the knob.

19. The method of claim 13, further comprising securing the support end of the first member to a surface of the span to be secured and securing the support end of the second member to a different surface of the span to be secured.

20. The method of claim 19, wherein securing the support ends of the first and second members comprises securing the support ends to the first and second members using at least one of screws, nails, adhesive, clamps, clips, and tape.
